(19) United States
(12) Patent Application Publication
(10) Pub. No.: US 2018/0348954 A1
(43) Pub. Date: Dec. 6, 2018

(54) CAPACITIVE SENSING USING A PHASE-SHIFTED MIXING SIGNAL

(71) Applicant: Synaptics Incorporated, San Jose, CA (US)

(72) Inventors: Eric Bohannon, Rochester, NY (US); Nooreldin Amer, Rochester, NY (US); Giri Mehta, Rochester, NY (US); Marshall Bell, Austin, TX (US)

(21) Appl. No.: 15/609,232

(22) Filed: May 31, 2017

(51) Int. Cl. G06F 3/041; G06F 3/044

(52) U.S. Cl. CPC G06F 3/0418; G06F 3/044; G06F 3/0412; G06F 2203/04111; G06F 2203/04108

(57) ABSTRACT

In a method of capacitive sensing, continuous time demodulation of a resulting signal received from a capacitive sensor is performed. The resulting signal measured is as a result of a modulated signal driven for capacitive sensing. An input object interaction is detected using the resulting signal. Responsive to detection of the input object interaction, a mixing signal is phase-shifted.

### BACKGROUND

Input devices including proximity sensor devices are widely used in a variety of electronic systems. A proximity sensor device typically includes a sensing region, often demarked by a surface, in which the proximity sensor device determines the presence, location and/or motion of one or more input objects. Proximity sensor devices may be used to provide interfaces for the electronic system. For example, proximity sensor devices are often used as input devices for larger computing systems (such as opaque touchpads integrated in, or peripheral to, notebook or desktop computers). Proximity sensor devices are also often used in smaller computing systems (such as touch screens integrated in cellular phones).

Many proximity sensing devices utilize capacitive sensing to detect, locate, and/or discriminate input objects within a sensing region of a capacitive sensing input device. Various aspects can degrade or reduce the quality and/or quantity of a capacitive resulting signal received from sensor electrode(s) that produce such a sensing region.

### SUMMARY

In a method of capacitive sensing, according to various embodiments, continuous time demodulation of a resulting signal received from a capacitive sensor is performed. The resulting signal measured is a result of a modulated signal driven for capacitive sensing. An input object interaction is detected using the resulting signal. Responsive to detection of the input object interaction, a mixing signal used in a mixer is phase-shifted.

A processing system for capacitive sensing, according to various embodiments, comprises a mixer, an operational amplifier, and a pair of current mirrors. The mixer is configured to receive a mixing signal. The operational amplifier is configured with a first input, a second input, and an output. The first input is configured to couple with a modulated signal; the output is coupled to the second input in a unity gain configuration; and the second input is configured to couple with and receive a resulting signal, in a form of an input current, from a capacitive sensor electrode. The pair of current mirrors is coupled with the operational amplifier and configured to convey an output current from the operational amplifier to the mixer. The mixer is configured to mix the output current with the mixing signal to achieve a mixed current as an output, and the processing system is configured to phase-shift the mixing signal in response to detection of an input object interaction using the resulting signal.

A capacitive sensing input device, according to various embodiments, comprises a sensor element pattern; and a processing system. The sensor element pattern comprises a plurality of capacitive sensor electrodes. The processing system, comprises: a mixer, an operational amplifier, and a pair of current mirrors. The mixer is configured to receive a mixing signal. The operational amplifier is configured with a first input, a second input, and an output. The first input is configured to couple with a modulated signal; the output is coupled to the second input in a unity gain configuration; and the second input is configured to couple with and receive a resulting signal, in a form of an input current, from a capacitive sensor electrode of the plurality of capacitive sensor electrodes. The pair of current mirrors is coupled with the operational amplifier and configured to convey an output current from the operational amplifier to the mixer. The mixer is configured to mix the output current with the mixing signal to achieve a mixed current as an output, and the processing system is configured to phase-shift the mixing signal in response to detection of an input object interaction using the resulting signal.

### BRIEF DESCRIPTION OF DRAWINGS

The accompanying drawings, which are incorporated in and form a part of the Description of Embodiments, illustrate various embodiments and, together with the Description of Embodiments, serve to explain principles discussed below, where like designations denote like elements. The drawings referred to in this Brief Description of Drawings should not be understood as being drawn to scale unless specifically noted.

FIG. 1 illustrates a block diagram of an example input device, in accordance with various embodiments.

FIG. 2 illustrates an example sensor element pattern that may be utilized to generate all or part of the sensing region of the input device, according to some embodiments.

FIG. 3 illustrates a schematic diagram of some components of an example processing system that may be utilized in an input device, according to various embodiments.

FIG. 4 illustrates an example diagram of sensor input currents (I_{IN}) versus time and a mixing signal (S_{MIX}) versus time for the input device of FIG. 3, according to various embodiments.

FIG. 5 illustrates an example diagram of the phase responses for the input device of FIG. 3, according to various embodiments.

FIG. 6 illustrates a flow diagram of an example method of capacitive sensing, according to various embodiments.

### DESCRIPTION OF EMBODIMENTS

The following Description of Embodiments is provided by way of example and not of limitation. Furthermore, there is no intention to be bound by any expressed or implied theory presented in the preceding Background, Summary, or Brief Description of Drawings or the following Description of Embodiments.

### Overview of Discussion

Various embodiments are described that provide input devices, processing systems, and methods that facilitate improved usability. In various described embodiments, the input device may be a capacitive sensing input device. Utilizing the described techniques, efficiencies may be achieved by shifting the phase of a mixing signal in an analog front-end of a processing system when the presence of an input object (such as a user's finger) is noted by the processing system to be touching or otherwise interacting with a proximity sensor device of a capacitive sensing input device to which the processing system is coupled. This phase-shift can reduce or eliminate capacitive baseline shift, which is defined as the measured capacitance changing (shifting) with the sensing frequency. As discussed, the phase-shifting of the mixing signal when an input object interaction (e.g., a touch event) is detected decreases this baseline shift by adjusting the relative phase of a mixing window such that the phase of the adjusted mixing window accounts for some or all of the delay introduced by the added capacitance of an input object when the input object touches or otherwise interacts with a proximity sensor device, such as a touch pad, touch screen, or the like. Some non-limiting other types of input object interactions besides touching include the input object hovering within a sensing region without any contact, the input object contacting an intervening material between the proximity sensor device and the input object, and the input object making some form of touch contact and undergoing biometric capacitive sensing (e.g., capacitive fingerprint sensing).

Discussion begins with a description of an example input device with which or upon which various described embodiments may be implemented. An example sensor element pattern is then described. This is followed by a description of an example processing system and some components thereof. The processing system may be utilized with or as a portion of an input device, such as a capacitive sensing input device. An example diagram of sensor input currents (I_{IN}) versus time and mixing signal (S_{MIX}) versus time is described, as is a diagram of some example phase responses. Operation of an input device, processing system, and components thereof are then further described in conjunction with description of an example method of capacitive sensing.

### Example Input Device

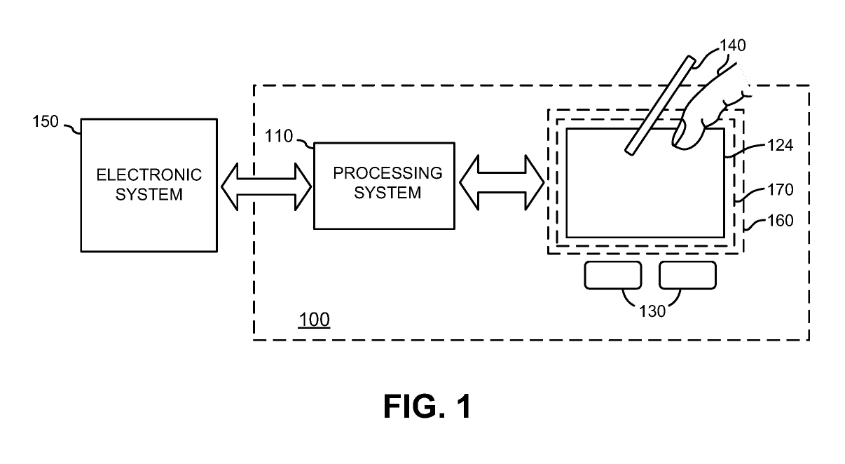

FIG. 1 is a schematic block diagram of an input device 100, in accordance with various embodiments. In some embodiments, input device 100 includes a display device 160, and comprises a touch screen interface with a sensing region 170 overlapping at least part of an active area of a display screen of the display screen of display device 160. For example, input device 100 may comprise substantially transparent sensor elements overlaying the display screen of a display device 160 and provide a touch screen interface. Display device 160, when included, may comprise any type of dynamic display screen capable of displaying a visual interface to a user. Although illustrated with a display device 160, some embodiments of input device 100 do not include and/or are not integrated with a display device such as display device 160.

Input device 100 may be configured to provide input to an electronic system 150. Input device 100 may be physically separate from or physically integrated with electronic system 150. Input device 100 may communicate with parts of electronic system 150 using any appropriate communication protocol/mechanism.

The term “electronic system” 150 broadly refers to any system capable of electronically processing information. Some non-limiting examples of electronic systems include personal computers, such as desktop computers, laptop computers, netbook computers, tablets, web browsers, e-book readers, and personal digital assistants. Additional example electronic systems include composite input devices, such as physical keyboards that include input device 100. Further example electronic systems include peripherals such as data input devices (including remote controls and mice), and data output devices (including display screens and printers). Other examples include remote terminals, kiosks, and video game machines (e.g., video game consoles, portable gaming devices, and the like). Other examples include communication devices (including cellular phones, such as smart phones), and media devices (including recorders, editors, and players such as televisions, set-top boxes, music players, digital photo frames, and digital cameras).

In FIG. 1, input device 100 is shown as a proximity sensor device (also often referred to as a “touchpad” or a “touch sensor device”) configured to sense input provided by one or more input objects 140 in a sensing region 170. Example input objects 140 include one or more fingers and/or styli, as shown in FIG. 1.

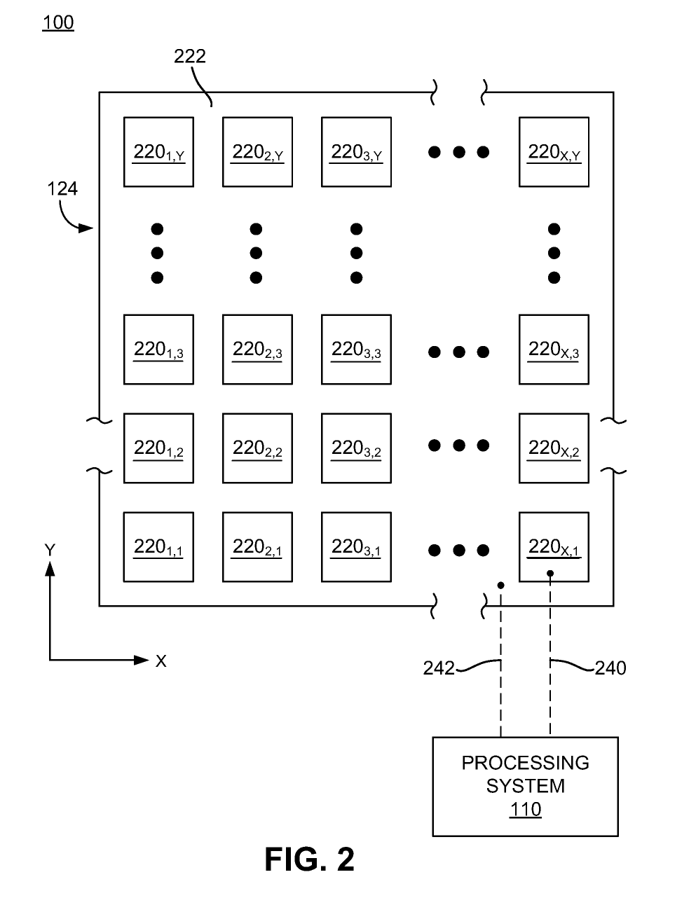

Input device 100 comprises a sensor element pattern 124 with one or more sensor elements for detecting user input in a sensing region 170. Some capacitive implementations utilize arrays or other regular or irregular patterns of sensor elements to create electric fields. In the capacitive sensing embodiment depicted in FIG. 2, a sensor element pattern 124 is illustrated which includes a plurality of sensor electrodes and one or more grid electrodes.

Sensing region 170 encompasses any space above, around, in and/or near input device 100 in which input device 100 detects user input provided by one or more input objects 140. In some embodiments, sensing region 170 extends from a surface of input device 100 in one or more directions into space until signal-to-noise ratios prevent sufficiently accurate object detection. Various embodiments sense input that comprises no contact with any surfaces of input device 100, contact with an input surface (e.g., a touch surface) of input device 100, contact with an input surface of input device 100 coupled with some amount of applied force or pressure, and/or a combination thereof. In various embodiments, input surfaces may be provided by surfaces of casings within which sensor electrodes reside, by face sheets applied over the sensor electrodes or any casings, etc.

Some capacitive implementations utilize “self capacitance” (or “absolute capacitance”) sensing methods based on changes in the capacitive coupling between sensor electrodes and an input object 140. In various embodiments, an input object 140 near the sensor electrodes alters the electric field near the sensor electrodes, changing the measured capacitive coupling. In one implementation, an absolute capacitance sensing method operates by modulating sensor electrodes with respect to a reference voltage (e.g., system ground), and by detecting the capacitive coupling between the sensor electrodes and input object(s) 140 as a resulting signal. “Modulating a sensor electrode” comprises processing system 110 or some other circuit driving a modulated signal onto the sensor electrode or otherwise modulating a potential of the sensor electrode with respect to another potential.

Some capacitive implementations utilize “mutual capacitance” (or “transcapacitance”) sensing methods based on changes in the capacitive coupling between sensor electrodes. In various embodiments, an input object 140 near the sensor electrodes alters the electric field between the sensor electrodes, thus changing the measured capacitive coupling. In one implementation, a transcapacitive sensing method operates by detecting the capacitive coupling between one or more “transmitter sensor electrodes” (also “transmitter electrodes”) and one or more “receiver sensor electrodes” (also “receiver electrodes”) as further described below. Transmitter sensor electrodes may be modulated relative to a reference voltage (e.g., system ground) to transmit a transmitter signals. Receiver sensor electrodes may be held substantially constant relative to the reference voltage to facilitate receipt of resulting signals. A resulting signal may comprise effect(s) corresponding to one or more transmitter signals, and/or to one or more sources of environmental interference (e.g., other electromagnetic signals). Sensor electrodes may be dedicated transmitter electrodes or receiver electrodes, or may be configured to both transmit transmitter signals and receive resulting signals.

Processing system 110 is configured to operate the hardware of input device 100 to detect input in sensing region 170. Processing system 110 comprises parts of or all of one or more Application Specific Integrated Circuits (ASICSs), one or more Integrated Circuits (ICs), one or more controllers, and/or other circuitry components, or some combination thereof. A processing system 110 for a capacitance sensing input device may comprise transmitter circuitry configured to transmit signals with transmitter sensor electrodes, and/or receiver circuitry configured to receive signals with receiver sensor electrodes. In some embodiments, processing system 110 comprises electronically-readable instructions, such as firmware code, software code, and/or the like. Processing system 110 may be coupled with and used to operate or provide information to one or more components of an electronic system 150, such as to a display, a wireless transceiver, an input device (e.g., an audio input device, an image input device, a proximity sensing input device, etc.).

Processing system 110 may be implemented as a set of modules that handle different functions. Different modules and combinations of modules may be used. For example, a sensor module may perform one or more of absolute capacitive sensing and transcapacitive sensing to detect inputs in the form of resulting signals received from one or more sensor elements, and a determination module may determine positions of inputs based on the detected capacitances and/or detected changes in capacitance in the resulting signals,

In some embodiments, processing system 110 operates sensor element pattern 124 of input device 100 to produce electrical signals (referred to as “resulting signals”) indicative of input or lack of input in sensing region 170. Processing system 110 may perform any appropriate amount of processing on the electrical signals. For example, processing system 110 may digitize analog electrical signals obtained from sensor element pattern 124. As another example, processing system 110 may perform filtering, demodulation, or other signal conditioning. In various embodiments, processing system 110 generates a capacitive image from the resulting signals received with sensor element pattern 124. In some embodiments, processing system 110 may determine positional information for detected input object(s) 140, recognize inputs as commands, recognize handwriting, and the like. “Positional information” broadly encompasses absolute position, relative position, velocity, acceleration, and other types of spatial information in various dimensions.

In some embodiments, processing system 110 responds directly to user input (or lack of user input) in sensing region 170 by causing one or more actions. Example actions include changing operation modes, as well as Graphic User Interface (GUI) actions such as cursor movement, selection, menu navigation, and other functions. In some embodiments, processing system 110 provides information about the input (or lack of input) to some part of the electronic system (e.g., to a central processing system of an electronic system 150 that is separate from processing system 110, if such a separate central processing system exists).

In some embodiments, input device 100 is implemented with additional input components, such as buttons 130, which may be operated by processing system 110. Other types of additional input components include sliders, balls, wheels, switches, and the like. Conversely, input device 100 may be implemented with no additional input components.

Some mechanisms of processing system 110 may be implemented and/or distributed as a software program on information bearing media (e.g., non-transitory computer-readable storage media) which include instructions readable by and executable by electronic processors. Some non-limiting examples of such media include various discs, memory sticks, memory cards, memory modules, and the like.

### Operation of Example Sensor Element Pattern and Example Processing System

FIG. 2 shows a portion of an example sensor element pattern 124 (sensor electrodes 220 and grid electrode(s) 222) configured to generate all or part of sensing region 170 and to sense inputs in sensing region 170, according to some embodiments. Processing system 110 is shown coupled to the sensor electrodes 220 via conductive traces 240 (e.g., like conductive trace 240 shown in dashed line coupled to sensor electrode 220_{X,Y}) and to grid electrode(s) by conductive trace(s) 242 (shown in dashed line). Processing system 110 and sensor element pattern 124 comprise a capacitive sensing embodiment of input device 100. In some touch screen embodiments, one or more of the sensor electrodes 220 and/or some portion of grid electrode 222 comprise one or more display electrodes used in updating the display of a display device 160 of the touch screen. In some touch screen embodiments, processing system 110 may further include components, modules, and/or circuitry configured to drive a display.

For purposes of clarity of illustration and description, a non-limiting simple sensor element pattern 124, comprising a matrix of rectangular sensor electrodes 220 (220_{1,1}, 220_{1,2}, 220_{1,3}, 220_{1,y}, 220_{2,1}, 220_{2,2}, 220_{2,3}, 220_{2,Y}, 220_{3,1}, 220_{3,2}, 220_{3,3}, 220_{3,Y}, 220_{X,1}, 220_{X,2}, 220_{X,3}, and 220_{X,Y})) and a grid electrode 222, has been illustrated. The matrix may be disposed in a variety of other shapes/arraignments and the sensor electrodes 220 may have other shapes. It is appreciated that, in other embodiments, numerous other capacitive sensor element patterns may be employed with the described techniques, including but not limited to: patterns with a single sensor electrode; patterns with a single set of sensor electrodes; patterns with two sets of sensor electrodes disposed in a single layer (without overlapping); patterns with two sets of sensor electrodes disposed in a single layer employing jumpers at crossover regions between sensor electrodes; patterns that utilize sensor electrodes in a crossing pattern, such as an X-Y crossing pattern; patterns that utilize one or more display electrodes of a display device such as one or more segments of a common voltage (V_{COM}) electrode; patterns with one or more of source electrodes, gate electrodes, anode electrodes, and cathode electrodes; and patterns that provide individual button electrodes.

Sensor element pattern 124 comprises an array of sensor electrodes 220 (referred collectively as sensor electrodes 220) arranged in X rows and Y columns along an X-Y axis, where X and Y are positive integers, although one of X and Y may be zero. Sensor electrodes 220 are typically ohmically isolated from each other, and also ohmically isolated from grid electrode 222. That is, one or more insulators (not shown) separate individual sensor electrodes 220 (and grid electrode 222) and prevent them from electrically shorting to each other. In some embodiments, sensor electrodes 220 and grid electrode 222 may additionally or alternatively be separated by insulative gap (not shown) surrounding an individual sensor electrode 220 (e.g., sensor electrode 220_{1,1}). An insulative gap separating sensor electrodes 220 and grid electrode 222 may be filled with an electrically insulating material, or may be an air gap. In some embodiments, sensor electrodes 220 and grid electrode 222 are vertically separated by one or more layers of insulative material. In some other embodiments, sensor electrodes 220 and grid electrode 222 are separated by one or more substrates; for example, they may be disposed on opposite sides of the same substrate, or on different substrates. In yet other embodiments, grid electrode 222 may comprise multiple layers on the same substrate, or on different substrates. In one embodiment, a first grid electrode may be formed on a first substrate or first side of a substrate and a second grid electrode may be formed on a second substrate or a second side of a substrate. For example, a first grid comprises one or more common electrodes disposed on a thin film transistor (TFT) layer of display device 160 and a second grid electrode is disposed on the color filter glass of display device 160.

In embodiments where sensor electrodes 220 are utilized with a display device, non-opaque conductive materials may be utilized for sensor electrodes 220. In embodiments where sensor electrodes 220 are not utilized with a display device, opaque conductive materials may be utilized for the sensor electrodes 220. Materials suitable for fabricating the sensor electrodes 220 include ITO, aluminum, silver, copper, molybdenum, and conductive carbon materials, among others. Sensor electrodes 220 may also be formed from a mesh of conductive material, such as a plurality of interconnected thin metal wires. Various sensor electrodes 220 may be formed of a stack of different conductive materials. Grid electrode 222 may be fabricated similarly to sensor electrodes 220.

Grid electrode 222 is disposed between at least two of the sensor electrodes 220. Grid electrode 222 may, in some embodiments, at least partially circumscribe the plurality of sensor electrodes 220 as a group, and may also, or in the alternative, completely or partially circumscribe one or more of the sensor electrodes 220. In one embodiment, grid electrode 222 is a planar body having a plurality of apertures, each aperture circumscribing a respective one of sensor electrodes 220. In some embodiments, grid electrode 222 may comprise a plurality of non-contiguous segments. In various embodiments, grid electrode 222 is disposed between at least two of sensor electrodes 220 such that grid electrode 222 is on different layer (i.e., different substrate or side of the same substrate) and overlaps a portion of at least two sensor electrodes and the gap between them.

In some embodiments, processing system 110 includes components, modules, and/or circuitry configured to drive a modulated signal or transmitter signal on at least one of the sensor electrodes 220 for capacitive sensing during periods in which input sensing is desired. Processing system 110 may also configured to operate grid electrode 222 as a shield electrode. Processing system 110 may also include components, modules, and/or circuitry configured to receive resulting signals with sensor element pattern 124 (sensor electrodes 220 and/or grid electrode(s) 222) comprising effects corresponding to the modulated signals or the transmitter signals during periods in which input sensing is desired. In some embodiments, processing system 110 further includes components, modules, and/or circuitry configured to determine a position of the input object 140 in sensing region 170 from the received resulting signals. In some embodiments, processing system 110 may provide a signal to another processor, for example to a host processor of electronic system 150. The signal may include information indicative of the determined position(s) of input object(s) 140 or information indicative of the resulting signal(s).

In a first mode of operation, the sensor electrodes 220 may be utilized to detect the presence (lack thereof) and/or position of an input object 140 via absolute sensing techniques. That is, processing system 110 is configured to modulate one or more sensor electrodes 220 to acquire measurements of changes in capacitive coupling between the modulated sensor electrodes 220 and an input object 140 to determine the position of the input object. Processing system 110 is further configured to determine changes of absolute capacitance based on a measurement of resulting signals received with sensor electrodes 220 which are modulated. Such resulting signals are utilized by processing system 110 or other processor to determine the presence and/or position of input object(s) 140.

In a second mode of operation, the sensor electrodes 220 may be utilized to detect the presence (or lack thereof) and/or position of an input object via transcapacitive sensing techniques when a transmitter signal is driven onto grid electrode 222. That is, processing system 110 is configured drive grid electrode 222 with a transmitter signal and receive resulting signals with each sensor electrode 220, where a resulting signal comprising effects corresponding to the transmitter signal, which is utilized by processing system 110 or other processor to determine the presence and/or position of input object(s) 140.

In a third mode of operation, the sensor electrodes 220 may be split into groups of transmitter and receiver electrodes utilized to detect the presence (lack thereof) and/or position of an input object via transcapacitive sensing techniques. That is, processing system 110 may drive a first group of sensor electrodes 220 with a transmitter signal and receive resulting signals with the second group of sensor electrodes 220, where a resulting signal comprising effects corresponding to the transmitter signal. The resulting signal is utilized by processing system 110 to determine the presence and/or position of input object(s) 140.

Input device 100 may be configured to operate in any one of the modes described above, and/or in other modes. Input device 100 may also be configured to switch between any two or more of the modes described above and/or other modes and/or to simultaneously operate different portions of sensor element pattern 124 in the same or different modes.

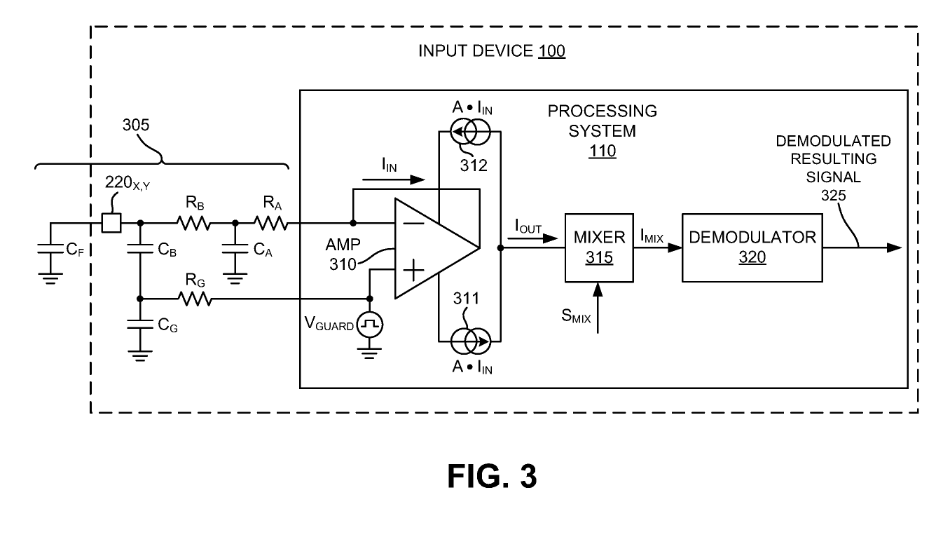

FIG. 3 illustrates a schematic diagram of some components of an example processing system 110 that may be utilized in an input device 100 that includes a sensor element pattern with one or more sensor electrodes, according to various embodiments. The components illustrated in processing system 110 of FIG. 3 perform functions of an analog front end of the processing system 110. In some capacitive sensing embodiments, processing system 110 also includes logic and/or circuitry for operating sensor electrodes of a sensor element pattern, such as sensor element pattern 124. For example, processing system 110 operates sensor element pattern 124 for capacitive sensing and processes resulting signals received from sensor electrodes 220 to determine the presence and/or position of input object(s) 140 with respect to a sensing region, such as sensing region 170.

As depicted in FIG. 3, components of the analog front end of processing system 110 include: amplifier 310, current mirror 311, current mirror 312, mixer 315, and demodulator 320.

Circuitry 305 represents the internal and inherent capacitances and resistances in an input device 100 that exist when measuring a background capacitance, C_{B}, and a finger capacitance, C_{F}, by coupling processing system (e.g., processing system 110) with a sensor electrode 220 (e.g., sensor electrode 220_{XY}) at a time when an input object 140 is touching or otherwise interacting with the sensor element pattern 124 that includes the sensor electrode 220. Resistance R_{A} represents the on chip (e.g., the integrated circuit or “chip” in which processing system 110 is implemented) routing resistance of a routing trace within a chip that couples amplifier 310 with routing trace 240. Resistance R_{B} represents a routing resistance, such as the resistance of routing trace (e.g., routing trace 240) that couples with the sensor electrode (e.g., sensor electrode 220_{XY}) of the sensor element pattern (e.g., sensor element pattern 124). Resistance R_{G} represents a routing resistance of the guard route, which may include the resistance routing traces both on the chip and on the sensor element pattern (e.g., routing trace 242) that couples V_{GUARD} with a guard electrode and is also utilized as a transmitter voltage. C_{A} represents the unguarded on-chip capacitance, and C_{G} represents capacitance of the guard route. Removing C_{F} from FIG. 3 would represent of a baseline condition when no input object 140 was interacting with sensor electrode 220_{XY}. Different representations than circuitry 305 are possible, however the general aspect of a baseline shift in a resulting signal, caused by the introduction of C_{F}, will typically remain.

A first input (the non-inverting input) of operational amplifier 310 is configured to couple with a modulated signal, such as the modulated voltage V_{GUARD}. A second input (the inverting input) is configured to couple with and receive a resulting signal, in the form of an input current, I_{IN}, from a capacitive sensor electrode (e.g., sensor electrode 220_{XY}, such as via routing trace such as 240 illustrated in FIG. 2). The output of amplifier 310 is coupled to the second input of amplifier 310 in a unity gain configuration. A pair of current mirrors 311 and 312 each have one side coupled with operational amplifier 310 as output current mirrors and their respective other sides coupled with one another at a common node. The current mirrors 311 and 312 form a current conveyor that is configured to convey an output current, I_{OUT}, from their common node.

Mixer 315 has two inputs and an output. On one of the two inputs, mixer 315 receives current, I_{OUT}, that is output from the common node between first current mirror 311 and second current mirror 312. On the other of the two inputs, mixer 315 receives a mixing signal, S_{MIX}. Mixer 315 operates to mix I_{OUT} with mixing signal S_{MIX} to achieve mixed current I_{MIX}. Mixer then outputs the mixed current, I_{MIX}. Processing system 110 controls the phase of the mixing signal, S_{MIX}. When a mixing signal, S_{MIX}, that is in phase with a resulting signal (and I_{MIX}) is used, 0% of I_{OUT} should eliminated or negated by being mixed by mixer 315. When a mixing signal, S_{MIX}, that is greater than 0 degrees and less than 90 degrees out of phase with the resulting signal (and I_{OUT}) is used, a portion of I_{OUT} will be eliminated or negated in the mixing process. Similarly, when a mixing signal that is 90 degrees out of phase with the resulting signal (and I_{OUT}) is used, most or all of I_{OUT} will be eliminated or negated in the mixing process.

In some embodiments, processing system 110 is configured to phase-shift the mixing signal, S_{MIX}, in response to detection of an input object interaction using the resulting signal that is received as an input to amplifier 310. In some embodiments, processing system 110 shifts the phase of S_{MIX} back to its un-shifted, or first phase, after presence of an input object is no longer detected using the resulting signals that is received as an input to amplifier 310. The presence of an input object 140 can be detected in numerous ways. One way is that the added capacitance, C_{F}, of the input object, increases the amplitude of the resulting signal over a signal that only includes background capacitance, C_{B}. In some embodiments, in response to processing system 110 noting this increase in amplitude in the resulting signal, it directs a phase shift in the mixing signal, S_{MIX}, from a first phase that is utilized for mixing when no input object contribution is noted in the resulting signal to a second phase. The first phase and the second phase are different, i.e., phase-shifted with respect to one another.

When processing system 110 phase-shifts the mixing signal, S_{MIX}, in response to detection of an input object interaction using the resulting signal that is received as an input to amplifier 310, the this may comprise phase-shifting the mixing signal by a predetermined amount from the mixing signal that is utilized when the presence of an input object interaction is not detected using the resulting signal that is received as an input to amplifier 310. In various embodiments, the predetermined amount of phase shift is greater than 0 degrees and less than 90 degrees. In some embodiments, the predetermined amount is set at 90 degrees of phase shift, which will typically eliminate the contribution of a baseline aspect of the resulting signal during the mixing process. The predetermined amount may be determined in advance, such as in a factory or laboratory, and then preset in memory or logic associated with processing system 110. For example, the predetermined amount may be equal to a phase difference between the resulting signal when an input object is detected and a baseline version of the resulting signal with no input object detected. When not determined in advance, either empirically, by estimation, or by other means, processing system 110 may dynamically determine the amount of phase shift to apply by incrementally increasing the phase shift of the mixing signal until the presence of the baseline signal has been minimized to a predetermined extent or else eliminated completely during a baseline condition when no input object interaction is present in a resulting signal; and/or by incrementally increasing the phase shift of the mixing signal until the presence of the amplitude of the I_{MIX} signal reaches a predetermined threshold or else reaches a maximum during a condition when an input object interaction is present in a resulting signal. A tradeoff for completely eliminating the presence of the baseline resulting signal in the mixing process is that overall signal amplitude, when C_{F} contributes to the resulting signal, will be lower due to eliminating some of this input-object-detecting resulting signal as well. In some embodiments, the baseline mixing signal (used when no input object interaction is detected) is set to be 90 degrees out of phase with the transmitter signal (e.g., V_{GUARD} in FIG. 3) and can be phase shifted to a different relationship with the modulated transmitter signal in response to detection of an input object interaction. For example, the mixing signal can be shifted such that it is greater than 90 degrees out of phase with the transmitter signal or else can be shifted such that it is more than 90 degrees out of phase and up to 180 degrees out of phase with the modulated transmitter signal.

In some embodiments, there are numerous modulated signals of differing frequencies that can be transmitted to the sensor element pattern for the purposes of capacitive sensing. In such an embodiment, modulated signal (e.g., V_{GUARD}) of FIG. 3 is only one transmitter signal of this plurality of modulated signals. For example, different frequencies of modulated transmitter signals may be used to avoid interference that is experienced in the environment in which capacitive sensing is conducted. Different frequencies of modulated transmitter signals may also be utilized simultaneously. In some such embodiments, where two or more of a plurality of modulated signals are modulated at different frequencies, in response to detecting an input object interaction using the resulting signal received as an input to amplifier 310, processing system 110 phase shifts the mixing signal, S_{MIX}, by an amount associated with a particular modulated frequency. For example, a first phase shift may be associated with a first modulated signal at a first frequency, a second and different amount of phase shift is associated with a second modulated signal of a second and different frequency, etc. The amounts of phase shift may be predetermined. Thus, when a particular one of a plurality of modulated signals is in use for capacitive sensing, the phase shift employed by processing system 110 in S_{MIX}, in response to detecting presence of an input object interaction using the resulting signal received at amplifier 310, may be a predetermined amount of phase shift that is associated with that particular modulated signal and its particular frequency of modulation.

With continued reference to FIG. 3, demodulator 320 is a continuous time demodulator. The mixed current, I_{MIX}, output from mixer 315 is received as an input to demodulator 320. Demodulator 320 demodulates I_{MIX} and outputs a demodulated resulting signal 325 which is utilized by processing system 110 for sensing presence and/or position of one or more input objects 140 with respect to sensing region 170.

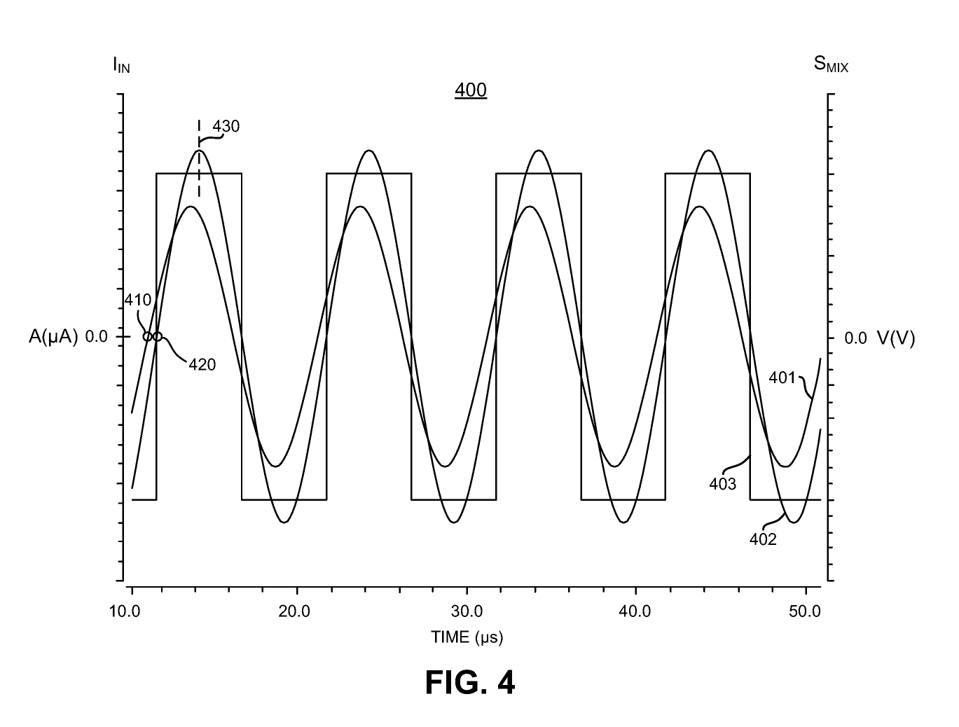

FIG. 4 illustrates a diagram 400 of example sensor input currents (I_{IN}) versus time and mixing symbol (S_{MIX}) versus time for the input device 100 of FIG. 3, according to various embodiments. Signals 401 and 402 are diagramed for the modeled circuitry 305, for two conditions. The first condition is where C_{F}=0 (in the condition with no input object interaction measured in resulting signal I_{IN}). The second condition is where C_{F} is some value greater than zero, such as 0.25 pF, 1 pF, 2 pF, or other non-zero value (in the condition with an input object interaction (e.g., finger touch of finger 140) measured in the resulting signal, I_{IN}).

It should be appreciated that signals 401 and 402 are not measured simultaneously, but instead at different times and then superimposed in time in FIG. 4. In FIG. 4, waveform 401 represents the input current, I_{IN} (e.g., the resulting signal) in the condition where C_{F}=0, with no input object 140 interacting with the sensor electrode 220 (e.g., 220_{XY}) from which the resulting signal is received. Waveform 402 represents the input current, I_{IN} (e.g., the resulting signal) in the condition where CF is greater than zero, with an input object 140 interacting with the sensor electrode 220 (e.g., 220_{XY}) from which the resulting signal is received. In particular, the input object 140 represented in signal 402 is a finger, and it is touching the capacitive sensing input device 100 from which the resulting signal is measured. As is apparent, the amplitude of signal 402 is greater than the amplitude of signal 401. Point 410 on signal 401 and point 420 on signal 402 are situated at the zero crossing points. The separation between these two points is measurable in time and is indicative of a phase shift between signal 401 and 402. This phase shift is due almost entirely to the added capacitance, C_{F}, being into the modeled capacitances and resistances when the input object interaction is present in signal 402. Signal 403 represents the waveform of the mixing signal, S_{MIX}, that is used when signal 402 is received. Dashed line 430 is centered on the 90 degree point of both signal 402 and signal 403. In one embodiment, when signal 401 is received, processing system 110 directs that a mixing signal, S_{MIX}, that is in phase with signal 401 be utilized in mixer 315; however, when signal 402 is received, processing system 110 directs phase-shifting I_{MIX} to the right by the same amount as the phase shift between signal 401 and signal 402 to achieve mixing signal 403 so that mixer 315 operates with a mixing signal that is in phase with signal 402. This phase-shift causes more of signal 402 to survive the mixing process than would have occurred without the phase-shift in the mixing signal. As one example, when there is a 5 degree phase shift to the right from signal 401 to signal 402, mixing signal 403 is shifted to the right by 5 degrees. As another example, when there is a 25 degree phase shift to the right from signal 401 to signal 402, mixing signal 403 is shifted to the right by 25 degrees.

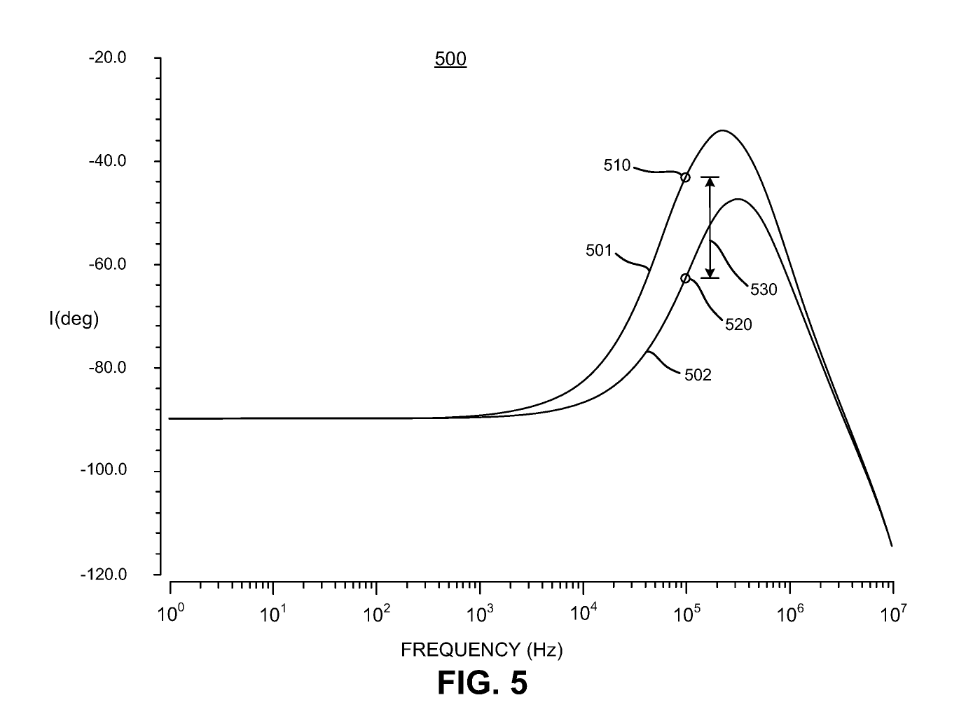

FIG. 5 illustrates a diagram 500 (e.g., a Bode plot) of example phase responses 501 and 502 for the input device 100 of FIG. 3, according to various embodiments. Phase responses 501 and 502 are diagramed for circuitry 305 for the range of V_{GUARD} frequencies of 10⁰ to 10⁷ Hz for two conditions. The first condition is where C_{F}=0 (in the condition with no input object interaction measured in resulting signal I_{IN}). The second condition is where C_{F} is some value greater than zero, such as 0.25 pF, 1 pF, 2 pF, or other non-zero value in the condition with an input object interaction (e.g., a finger touch of finger 140) measured using the resulting signal, I_{IN}.

It should be appreciated that responses 501 and 502 are not measured simultaneously, but instead at different times and then superimposed in FIG. 5. Response curve 501 is for the condition C_{F}=0, while response curve 502 is for the condition where C_{F} is greater than zero. The results of points 510 and 520, both at 100 kHz, show that at 100 kHz, the phase difference/shift 530 for the conditions of “C_{F}=0” and “C_{F}=greater than zero,” as was previously illustrated in FIG. 4. This would result in less baseline shift at 100 kHz relative to what would have been achieved had the phase of the mixing waveform been optimized to maximize the baseline response, rather than being shifted in response to detection of an input object interaction using the resulting signal.

While sinewave signals have been utilized to produce the results illustrated in FIGS. 4 and 5, the described techniques are applicable to other waveforms, such as square wave transmissions. Additionally, while FIGS. 4 and 5 illustrate results of absolute capacitive sensing with a sensor electrode of a matrixed sensor element pattern such as the one illustrated in FIG. 2, it should be appreciated that the same techniques can be applied to transcapacitive sensing with the illustrated matrixed sensor element pattern and can also be applied to absolute and transcapacitive sensing with other types sensor element patterns (e.g., matrixed, crossing, single layer, and others).

While FIGS. 4 and 5 illustrate signals and responses while operating with particular circuit component and inherent resistance and capacitance values and a modulated transmitter signal of 100 kHz, it should be appreciated that similar operations can occur when: the processing system 110 and/or sensor element pattern have different component and inherent resistance and capacitance values; when the no input object present/input object present capacitances are different; and/or when a modulated signal of a different frequency is transmitted for capacitive sensing. The modulated signal used by processing system 110 as a transmitter signal may be at any frequency at which sensing can be effectively conducted. In some embodiments, the modulated signal used as a transmitter signal is between 1 kHz and 100 Mhz. In some embodiments, the modulated signal used as a transmitter signal is between 50 kHz and 100 Mhz. In some embodiments, the modulated signal used as a transmitter signal is between 50 kHz and 50 MHz. In some embodiments, the modulated signal used as a transmitter signal is between 50 kHz and 20 Mhz. In some embodiments, the modulated signal used as a transmitter signal is between 75 kHz and 2 Mhz. Other ranges for transmitter signals are possible, as are higher and/or lower frequencies than those listed in the examples. It should be appreciated that there may be several modulated signals that can be selected from in any range of operation. In some embodiments, the frequency of the modulated signal may be selected based, at least in part, on the type of sensing conducted. For example, a different modulated frequency may be utilized for capacitive touch sensing than for capacitive fingerprint sensing.

Although a switch between a phase-shifted mixing signal (employed when an input object is sensed in a resulting signal) and a non-phase shifted mixing signal (employed in baseline conditions when no input object is sensed using a resulting signal) takes place in many described embodiments, in some other embodiments, mixer 315 may simply utilize the phase-shifted signal full time with the tradeoff of losing some to all of any baseline condition resulting signal during the mixing process and reducing overall signal to noise ratio (SNR) of at least the baseline condition resulting signal. In another embodiment, processing system 110 sets fixed phase-shifted relationship between the phase of the baseline resulting signal and the phase of the mixing signal, S_{MIX}, such that a desired/predetermined SNR is maintained for either or both of the conditions where: 1) there is no input object interaction measured in the resulting signal, and 2) there is an input object interaction measured in the resulting signal.

### Example Methods of Operation

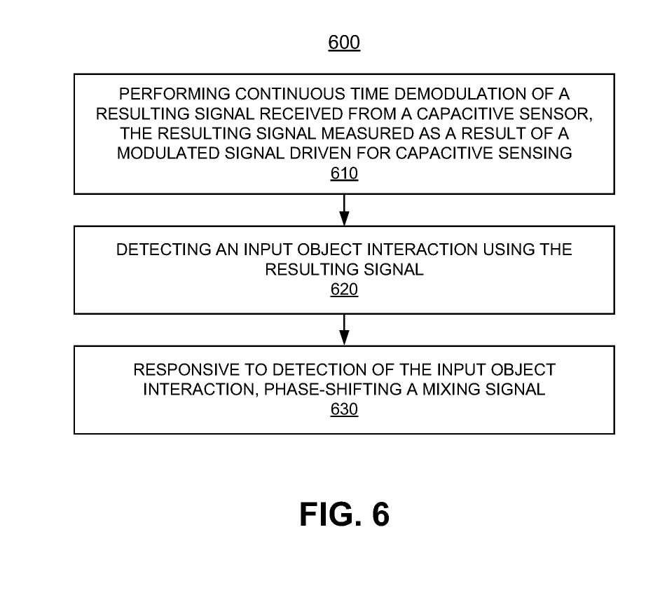

FIG. 6 illustrate a flow diagram 600 of a method of capacitive sensing, according to various embodiments. Procedures of this method will be described with reference to elements and/or components of one or more of FIGS. 1-5. It is appreciated that in some embodiments, the procedures may be performed in a different order than described, that some of the described procedures may not be performed, and/or that one or more additional procedures to those described may be performed.

With reference to FIG. 6, at procedure 610 of flow diagram 600, in one embodiment, continuous time demodulation of a resulting signal received from a capacitive sensor is performed, the resulting signal measured as a result of a modulated signal driven for capacitive sensing. As discussed above, the resulting signal is a capacitive sensing resulting signal received at a processing system, such as processing system 110, from one or more elements of sensor element matrix. For example, the resulting signal may be received from a single sensor electrode (e.g., sensor electrode 220_{X,Y}) of a sensor element pattern (e.g., sensor element pattern 124) of from a plurality of sensor electrodes of a sensor element pattern. The modulated signal is a transmitter signal that is transmitted to the sensor element pattern as part of the process of capacitive sensing. The demodulator is a continuous time demodulator, such as demodulator 320, that is disposed as a portion of a processing system that receives and processes signals that result from the transmission of the transmitter signal.

With continued reference to FIG. 6, at procedure 620 of flow diagram 600, in one embodiment, an input object interaction is detected using the resulting signal. This can comprise processing system 110 detecting the presence of the input object interaction using the resulting signal. The input object interaction may comprise a finger or other input object 140 touching or otherwise detectably interacting with an input device 100. For example, this detection can comprise direct detection of the input object through complete processing of a resulting signal by processing system 110, or can comprise detection of changes in a resulting signal that are indicative of the presence of an input object. For example, detection may comprise processing system 110 detecting changes in a resulting signal relative to a baseline condition of the resulting signal that are indicative of input object interaction. Such changes relative to the baseline may comprise a rise in amplitude above a predetermined threshold or a predetermined percentage greater than the baseline resulting signal when no input object interaction is occurring.

With continued reference to FIG. 6, at procedure 630 of flow diagram 600, in one embodiment, responsive to detection of the input object interaction using the resulting signal, a mixing signal is shifted in phase. The mixing signal is an input to a mixer and is mixed by the mixer with another signal that is received as an input to the mixer. Generally, this is described and depicted as a rightward phase-shift of a mixing signal from a baseline mixing signal (e.g., S_{MIX} of FIG. 3) that is utilized in a mixer (e.g., mixer 315) when no input object interaction has been detected (e.g., in I_{IN} of FIG. 3). This phase-shifting may comprise processing system 110 shifting the phase of the mixing signal by an amount that has been preset and/or predetermined. This phase-shifting may also comprise processing system 110 dynamically determining the amount of phase shift to apply to the mixing signal.

The phase-shift applied to the mixing signal is greater than zero degrees. In some embodiments, this may comprise processing system 110 phase-shifting the mixing signal by 90 degrees from the baseline mixing signal. In some embodiments, this may comprise processing system 110 phase-shifting the mixing signal by an amount greater than 0 degrees and less than 90 degrees from the baseline mixing signal (such as in a range between 3 degrees and 30 degrees, as but one example). In some embodiments, this comprises processing system 110 phase-shifting the mixing signal by an amount equal to, or within a narrow range such as two degrees plus or minus, of a phase difference between the resulting signal when an input object interaction is detected and a baseline version of resulting signal with no input object interaction detected.

In some embodiments, the modulated signal described in procedure 610 may be one of a plurality of modulated signals that can be transmitted by a processing system as a transmitter signal, some or all of which differ in frequency. In such an embodiment, where the modulated signal is one of a plurality of modulated signals that comprises at least a second modulated signal modulated at a different frequency than the modulated signal. It should be appreciated that there may be more than two modulated signals and some or all of these modulated signals may be modulated at different frequencies from one another. In some embodiments, the above described phase-shifting of the mixing signal used in the mixer comprises phase-shifting the mixing signal by a predetermined amount associated with the one of the plurality of modulated signals that has been utilized in capacitive sensing to generate the resulting signal that is being processed. In some embodiments, where a plurality of modulated signals exists and two or more are modulated at different frequencies, a first predetermined phase-shift is associated with a first modulated signal that has been modulated at a first frequency while a second phase-shift, that is different from the first phase-shift, is associated with a second modulated signal that has been modulated at a second frequency that is different from the first frequency. Predetermined amounts of phase-shift(s) associated with particular modulated signal(s) may be stored in a processing system and/or memory during manufacture, and may be determined empirically or by any other suitable manner

The examples set forth were presented in order to best explain, to describe particular applications, and to thereby enable those skilled in the art to make and use embodiments of the described examples. However, those skilled in the art will recognize that the foregoing description and examples have been presented for the purposes of illustration and example only. The description as set forth is not intended to be exhaustive or to limit the embodiments to the precise form disclosed.

Reference throughout this document to “one embodiment,” “certain embodiments,” “an embodiment,” “various embodiments,” “some embodiments,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics may be combined in any suitable manner on one or more embodiments without limitation.

What is claimed is:

1. A method of capacitive sensing comprising:
performing continuous time demodulation of a resulting signal received from a capacitive sensor, the resulting signal measured as a result of a modulated signal driven for capacitive sensing;
detecting an input object interaction; and
responsive to detection of the input object interaction in the resulting signal, phase-shifting a mixing signal.

2. The method as recited in claim 1, wherein the phase-shifting a mixing signal comprises:
phase-shifting the mixing signal by a predetermined amount.

3. The method as recited in claim 1, wherein the phase-shifting a mixing signal comprises:
phase-shifting the mixing signal by 90 degrees.

4. The method as recited in claim 1, wherein the phase-shifting a mixing signal comprises:
phase-shifting the mixing signal by an amount greater than 0 degrees and less than 90 degrees.

5. The method as recited in claim 1, wherein the phase-shifting a mixing signal comprises:
phase-shifting the mixing signal by an amount equal to a phase difference between the resulting signal and a baseline version of the resulting signal with no input object interaction detected.

6. The method as recited in claim 1, wherein the modulated signal is one of a plurality of modulated signals that comprises a second modulated signal modulated at a different frequency than the modulated signal, and wherein the phase-shifting a mixing signal comprises:
phase-shifting the mixing signal by a predetermined amount associated with the modulated signal, wherein a different phase-shift is associated with the second modulated signal.

7. A processing system for capacitive sensing, the processing system comprising:
a mixer configured to receive a mixing signal;
an operational amplifier with a first input, a second input, and an output, wherein:
the first input is configured to couple with a modulated signal;
the output is coupled to the second input in a unity gain configuration; and
the second input is configured to couple with and receive a resulting signal, in a form of an input current, from a capacitive sensor electrode;
a pair of current mirrors coupled with the operational amplifier and configured to convey an output current from the operational amplifier to the mixer; and
a continuous time demodulator coupled to and configured to receive a mixed current output from the mixer;
wherein the mixer is configured to mix the output current with the mixing signal to achieve a mixed current as an output, and wherein the processing system is configured to phase-shift the mixing signal in response to detection of an input object interaction using the resulting signal.

8. The processing system of claim 7, wherein the phase-shift is a predetermined amount of phase-shift.

9. The processing system of claim 7, wherein the phase-shift is a 90 degree phase-shift.

10. The processing system of claim 7, wherein the phase-shift is within a range of an amount greater than 0 degrees and less than 90 degrees.

11. The processing system of claim 7, wherein the phase-shift is an amount equal to a phase difference between the resulting signal and a baseline version of the resulting signal with no input object interaction detected.

12. The processing system of claim 7, wherein the modulated signal is one of a plurality of modulated signals that comprises a second modulated signal modulated at a different frequency than the modulated signal, wherein the phase-shift comprises a predetermined amount of phase-shift associated with the modulated signal, and wherein a different phase-shift is associated with the second modulated signal.

13. A capacitive sensing input device comprising:
a sensor element pattern comprising a plurality of capacitive sensor electrodes; and
a processing system comprising;
a mixer configured to receive a mixing signal;
an operational amplifier with a first input, a second input, and an output, wherein:
the first input is configured to couple with a modulated signal;
the output is coupled to the second input in a unity gain configuration; and
the second input is configured to couple with and receive a resulting signal, as an input current, from a capacitive sensor electrode of the plurality of capacitive sensor electrodes;
a pair of current mirrors coupled with the operational amplifier and configured to convey an output current from the operational amplifier to the mixer; and
a continuous time demodulator coupled to and configured to receive a mixed current output from the mixer;
wherein the mixer is configured to mix the output current with the mixing signal to achieve a mixed current as an output, and wherein the processing system is configured to phase-shift the mixing signal in response to detection of an input object interaction using the resulting signal.

14. The capacitive sensing input device of claim 13, wherein the phase-shift is a predetermined amount of phase-shift.

15. The capacitive sensing input device of claim 13, wherein the phase-shift is dynamically determined.

16. The capacitive sensing input device of claim 13, wherein the phase-shift is a 90 degree phase-shift.

17. The capacitive sensing input device of claim 13, wherein the phase-shift is within a range of an amount greater than 0 degrees and less than 90 degrees.

18. The capacitive sensing input device of claim 13, wherein the phase-shift is an amount equal to a phase difference between the resulting signal and a baseline version of the resulting signal with no input object interaction detected.

19. The capacitive sensing input device of claim 13, wherein the modulated signal is one of a plurality of modulated signals that comprises a second modulated signal modulated at a different frequency than the modulated signal, wherein the phase-shift comprises a predetermined amount of phase-shift associated with the modulated signal, and wherein a different phase-shift is associated with the second modulated signal.

20. The capacitive sensing input device of claim 13, wherein the capacitive sensor electrode is one of a plurality of sensor electrodes arranged in a matrix.
